(19) United States
(12) Patent Application Publication
(10) Pub. No.: US 2003/0063095 A1
(43) Pub. Date: Apr. 3, 2003

(54) Statistic logic for collecting a histogram of pixel exponent values

(75) Inventors: Alan W. Cheung, San Jose, CA (US); Michael F. Deering, Los Altos, CA (US)

Correspondence Address: Jeffrey C. Hood, Conley, Rose & Tayon, P.C., P.O. Box 398, Austin, TX, 78767, US

(73) Assignee: Sun Microsystems, Inc.

(21) Appl. No.: 10/195,859

(22) Filed: Jul. 15, 2002

Related U.S. Application Data
(63) Continuation-in-part of application No. 09/751,673, filed on Dec. 29, 2000.

(51) Int. Cl. G09G 5/00

(52) U.S. Cl. 345/582

(57) ABSTRACT

A system including a rendering engine, a sample buffer and a filtering unit. The rendering engine is configured to render samples in response to received graphics data. The sample buffer is configured to receive and store the samples. The filtering unit is configured to read and filter the samples stored in the sample buffer to generate pixel values. The filtering unit includes a counter controller, a set of positive counters and a set of negative counter. The counter controller is configured to accumulate a histogram of exponent values of the pixel values in the positive counters and negative counters. The positive counters maintain count values for exponents of positively signed pixel values and the negative counters maintain count values for exponents of negatively signed pixel values.

### CONTINUATION DATA

This application is a continuation-in-part of copending U.S. patent application Ser. No. 09/751,673, filed on Dec. 29, 2000, entitled “Dynamically Adjusting a Sample-to-Pixel Filter to Compensate for the Effects of Negative Lobes”, invented by Michael F. Deering. This copending application is hereby incorporated by reference in its entirety.

### BACKGROUND OF THE INVENTION

1. Field of the Invention

This invention relates generally to the field of computer graphics and, more particularly, to a system and method for computing and reporting pixel computation statistics from a graphics accelerator to a host computer.

2. Description of the Related Art

A graphics accelerator may receive a stream a graphics data, and perform rendering computations to determine a stream of video pixels which are presented to a display device. The graphics accelerator may perform super-sampling and super-sample filtering to determine the video pixels. However, when using filters with negative lobes such as the truncated sync filter, it is possible to obtain negative pixel values even though all the super-sample values are non-negative quantities. Negative pixel values may need to be clamped to zero. The clamping to zero compromises visual quality of the output video. Thus, there exist a need for a system and methodology for controlling or minimizing the occurrence of negative pixels.

In addition, it would be desirable for host software (i.e. software running on a host computer coupled to the graphics accelerator) to receive a reporting of any relevant statistics from programmable circuit devices in the graphics accelerator. Thus, the host software may be able to adjust programmable features of the circuit devices to optimize their behavior.

### SUMMARY

A system including a rendering engine, a sample buffer and a filtering unit. The rendering engine is configured to render samples in response to received graphics data. The sample buffer is configured to receive and store the samples. The filtering unit is configured to read and filter the samples stored in the sample buffer to generate pixel values. The filtering unit includes a counter controller, a set of positive counters and a set of negative counter. The counter controller is configured to accumulate a histogram of exponent values of the pixel values in the positive counters and negative counters. The positive counters maintain count values for exponents of positively signed pixel values and the negative counters maintain count values for exponents of negatively signed pixel values.

### BRIEF DESCRIPTION OF THE DRAWINGS

A better understanding of the present invention can be obtained when the following detailed description is considered in conjunction with the following drawings, in which:

FIG. 1 illustrates one set of embodiments of a graphics accelerator configured to perform graphical computations;

FIG. 2 illustrates one set of embodiments of a parallel rendering engine;

FIG. 3 illustrates an array of spatial bins each populated with a set of sample positions in a two-dimension virtual screen space;

FIG. 4 illustrates one set of embodiments of a rendering methodology which may be used to generate samples in response to received stream of graphics data;

FIG. 5 illustrates a set of candidate bins which intersect a particular triangle;

FIG. 6 illustrates the identification of sample positions in the candidate bins which fall interior to the triangle;

FIG. 7 illustrates the computation of a red sample component based on a spatial interpolation of the red components at the vertices of the containing triangle;

FIG. 8 illustrates an array of virtual pixel positions distributed in the virtual screen space and superimposed on top of the array of spatial bins;

FIG. 9 illustrates the computation of a pixel at a virtual pixel position (denoted by the plus marker) according to one set of embodiments;

FIG. 10 illustrates a set of columns in the spatial bin array, wherein the Kth column defines the subset of memory bins (from the sample buffer) which are used by a corresponding filtering unit FU(K) of the filtering engine;

FIG. 11 illustrates one set of embodiments of filtering engine 600;

FIG. 12 illustrates one embodiment of a computation of pixels at successive filter center (i.e. virtual pixel centers) across a bin column;

FIG. 13 illustrates one set of embodiments of a rendering pipeline comprising a media processor and a rendering unit;

FIG. 14 illustrates one embodiment of graphics accelerator 100;

FIG. 15 illustrates another embodiment of graphics accelerator 100; and

FIG. 16

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note, the headings are for organizational purposes only and are not meant to be used to limit or interpret the description or claims. Furthermore, note that the word “may” is used throughout this application in a permissive sense (i.e., having the potential to, being able to), not a mandatory sense (i.e., must).” The term “include”, and derivations thereof, mean “including, but not limited to”. The term “connected” means “directly or indirectly connected”, and the term “coupled” means “directly or indirectly connected”.

### DETAILED DESCRIPTION OF THE PREFERRED EMBODIMENTS

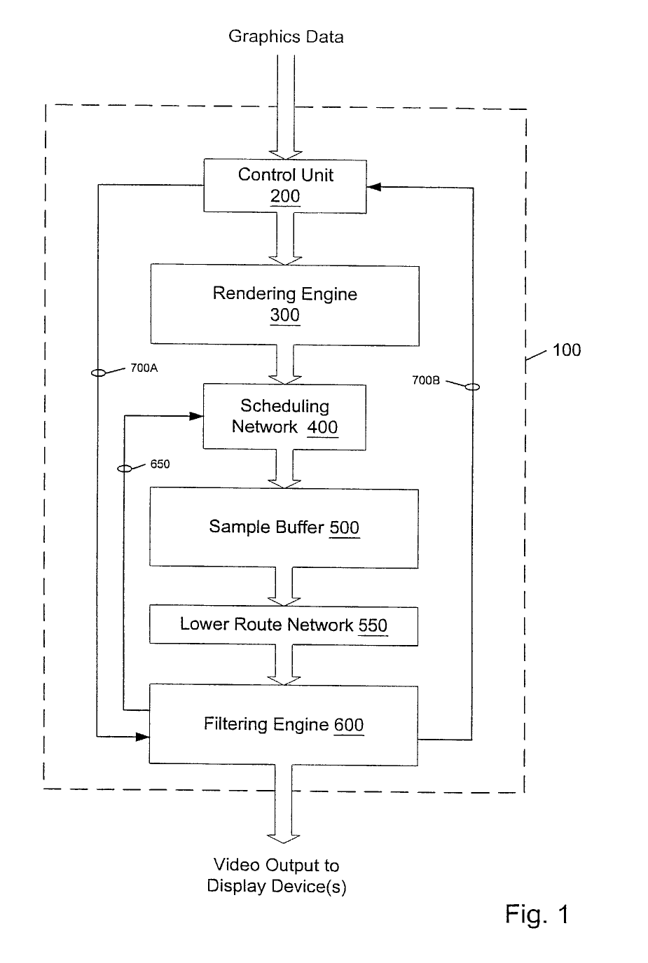

FIG. 1 illustrates one set of embodiments of a graphics accelerator 100 configured to perform graphics computations (especially 3D graphics computations). Graphics accelerator 100 may include a control unit 200, a rendering engine 300, a scheduling network 400, a sample buffer 500, a lower route network 550, and a filtering engine 600.

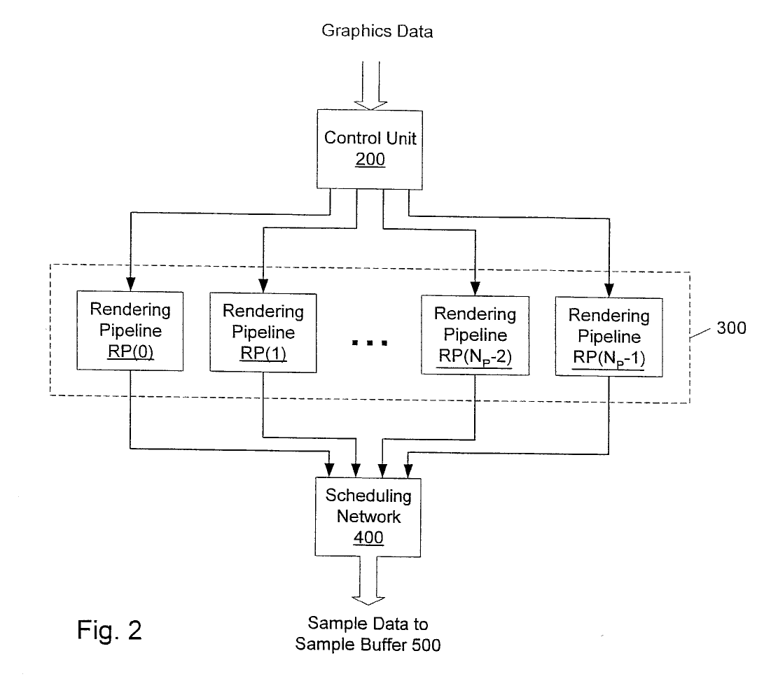

The rendering engine 300 may include a set of N_{PL} rendering pipelines as suggested by FIG. 2, where N_{PL} is a positive integer. The rendering pipelines, denoted as RP(0) through RP(N_{PL}−1), are configured to operate in parallel. For example, in one embodiment, N_{PL} equals four. In another embodiment, N_{PL}=8.

The control unit 200 receives a stream of graphics data from an external source (e.g. from the system memory of a host computer), and controls the distribution of the graphics data to the rendering pipelines. The control unit 200 may divide the graphics data stream into N_{PL} substreams, which flow to the N_{PL} rendering pipelines respectively. The control unit 200 may implement an automatic load-balancing scheme so the host application need not concern itself with load balancing among the multiple rendering pipelines.

The stream of graphics data received by the control unit 200 may correspond to a frame of a 3D animation. The frame may include a number of 3D objects. Each object may be described by a set of primitives such as polygons (e.g. triangles), lines, polylines, dots, etc. Thus, the graphics data stream may contain information defining a set of primitives.

Polygons are naturally described in terms of their vertices. Thus, the graphics data stream may include a stream of vertex instructions. A vertex instruction may specify a position vector (X,Y,Z) for a vertex. The vertex instruction may also include one or more of a color vector, a normal vector and a vector of texture coordinates. The vertex instructions may also include connectivity information, which allows the rendering engine 300 to assemble the vertices into polygons (e.g. triangles).

Each rendering pipeline RP(K) of the rendering engine 300 may receive a corresponding stream of graphics data from the control unit 200, and performs rendering computations on the primitives defined by the graphics data stream. The rendering computations generate samples, which are written into sample buffer 500 through the scheduling network 400.

The filtering engine 600 is configured to read samples from the sample buffer 500, to perform a filtering operation on the samples resulting in the generation of a video pixel stream, and, to convert the video pixel stream into an analog video signal. The analog video signal may be supplied to one or more video output ports for display on one or more display devices (such as computer monitors, projectors, head-mounted displays and televisions).

Furthermore, the graphics system 100 may be configured to generate up to N_{D} independent video pixel streams denoted VPS(0), VPS(1), . . . , VPS(N_{D}−1), where N_{D} is a positive integer. Thus, a set of host applications (running on a host computer) may send N_{D} graphics data streams denoted GDS(0), GDS(1), . . . , GDS(N_{D}−1) to the graphics system 100. The rendering engine 300 may perform rendering computations on each graphics data stream GDS(I), for I=0, 1, 2, . . . , N_{D}−1, resulting in sample updates to a corresponding region SBR(I) of the sample buffer 500. The filtering engine 600 may operate on the samples from each sample buffer region SBR(I) to generate the corresponding video pixel stream VPS(I). The filtering engine 600 may convert each video pixel stream VPS(I) into a corresponding analog video signal AVS(I). The N_{D} analog video signals may be supplied to a set of video output ports for display on a corresponding set of display devices. In one embodiment, N_{D} equals two. In another embodiment, N_{D} equals four.

The filtering engine 600 may send sample data requests to the scheduling network 400 through a request bus 650. In response to the sample data requests, scheduling network 400 may assert control signals, which invoke the transfer of the requested samples (or groups of samples) to the filtering engine 600.

In various embodiments, the sample buffer 500 includes a plurality of memory units, and the filtering engine 600 includes a plurality of filtering units. The filtering units interface may interface with the lower router network 550 to provide data select signals. The lower route network 550 may use the data select signals to steer data from the memory units to the filtering units.

The control unit 200 may couple to the filtering engine 600 through a communication bus 700, which includes an outgoing segment 700A and a return segment 700B. The outgoing segment 700A may be used to download parameters (e.g. lookup table values) to the filtering engine 600. The return segment 700B may be used as a readback path for the video pixels generated by filtering engine 600. Video pixels transferred to control unit 200 through the return segment 700B may be forwarded to system memory (i.e. the system memory of a host computer), or perhaps, to memory (e.g. texture memory) residing on graphics system 100 or on another graphics accelerator.

The control unit 200 may include direct memory access (DMA) circuitry. The DMA circuitry may be used to facilitate (a) the transfer of graphics data from system memory to the control unit 200, and/or, (b) the transfer of video pixels (received from the filtering engine 600 through the return segment 700B) to any of various destinations (such as the system memory of the host computer).

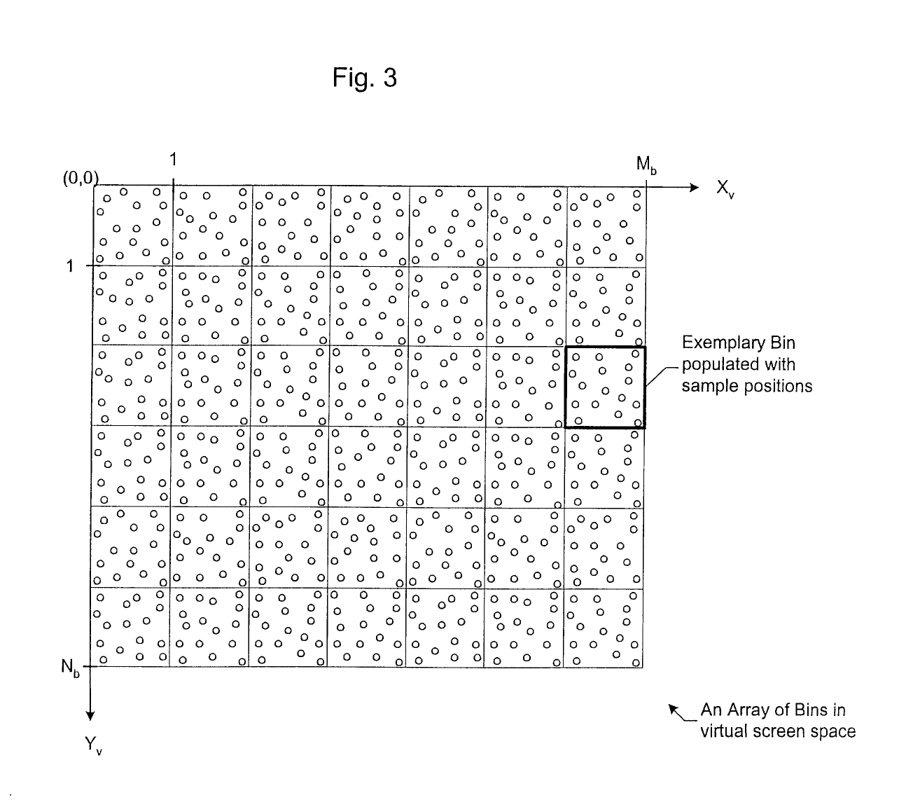

The rendering pipelines of the rendering engine 300 may compute samples for the primitives defined by the received graphics data stream(s). The computation of samples may be organized according to an array of spatial bins as suggested by FIG. 3. The array of spatial bins defines a rectangular window in a virtual screen space. The spatial bin array may have dimension M_{B}×N_{B}, i.e., may comprise M_{B} bins horizontally and N_{B} bins vertically.

Each spatial bin may be populated with a number of sample positions. Sample positions are denoted as small circles. Each sample position may be defined by a horizontal offset and a vertical offset with respect to the origin of the bin in which it resides. The origin of a bin may be at its top-left corner. Note that any of a variety of other positions on the boundary or in the interior of a bin may serve as its origin. A sample may be computed at each of the sample positions. A sample may include a color vector, and other values such as z depth and transparency (i.e. an alpha value).

The sample buffer 500 may organize the storage of samples according to memory bins. Each memory bin corresponds to one of the spatial bins, and stores the samples for the sample positions in a corresponding spatial bin.

If a rendering pipeline RP(k) determines that a spatial bin intersects with a given primitive (e.g. triangle), the rendering pipeline may:

(a) generate N_{s/b} sample positions in the spatial bin;

(b) determine which of the N_{s/b} sample positions reside interior to the primitive;

(c) compute a sample for each of the interior sample positions, and

(d) forward the computed samples to the scheduling network 400 for transfer to the sample buffer 500.

The computation of a sample at a given sample position may involve computing sample components such as red, green, blue, z, and alpha at the sample position. Each sample component may be computed based on a spatial interpolation of the corresponding components at the vertices of the primitive. For example, a sample's red component may be computed based on a spatial interpolation of the red components at the vertices of the primitive.

In addition, if the primitive is to be textured, one or more texture values may be computed for the intersecting bin. The final color components of a sample may be determined by combining the sample's interpolated color components and the one or more texture values.

Each rendering pipeline RP(K) may include dedicated circuitry for determining if a spatial bin intersects a given primitive, for performing steps (a), (b) and (c), for computing the one or more texture values, and for applying the one or more texture values to the samples.

Each rendering pipeline RP(K) may include programmable registers for the bin array size parameters M_{B} and N_{B} and the sample density parameter N_{s/b}. In one embodiment, N_{s/b} may take values in the range from 1 to 16 inclusive.

Sample Rendering Methodology

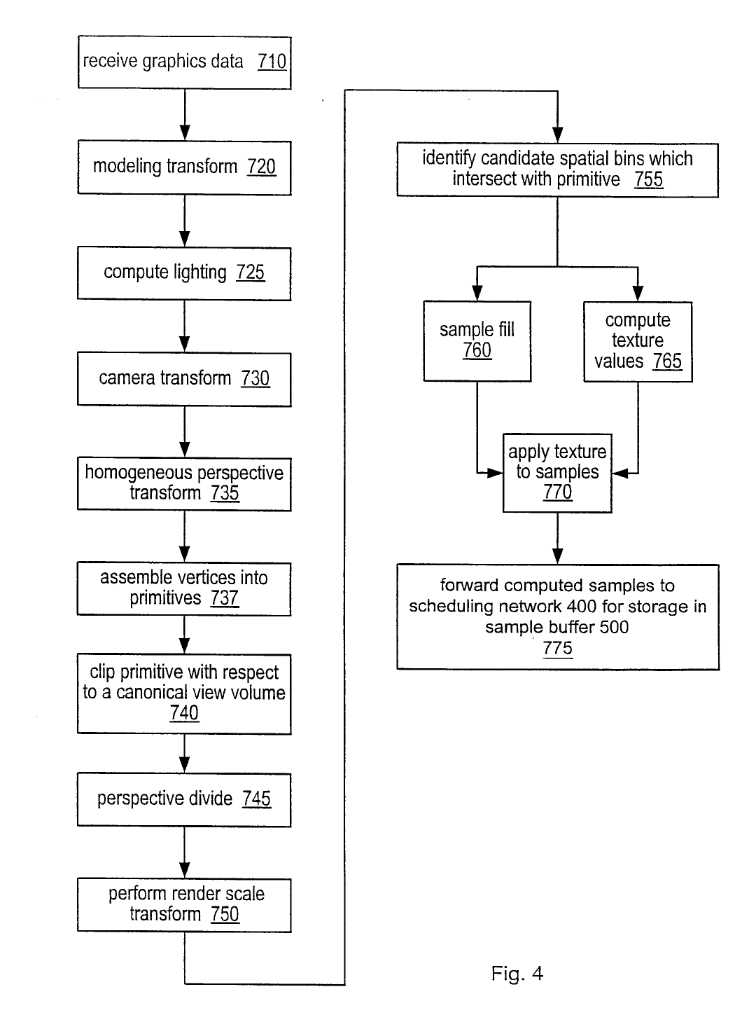

FIG. 4 illustrates one set of embodiments of a rendering process implemented by each rendering pipeline RP(K) of the N_{PL} rendering pipelines.

In step 710, rendering pipeline RP(K) receives a stream of graphics data from the control unit 200 (e.g. stores the graphics data in an input buffer).

The graphics data may have been compressed according to any of a variety of data compression and/or geometry compression techniques. Thus, the rendering pipeline RP(K) may decompress the graphics data to recover a stream of vertices.

In step 720, the rendering pipeline RP(K) may perform a modeling transformation on the stream of vertices. The modeling transformation serves to inject objects into a world coordinate system. The modeling transformation may also include the transformation of any normal vectors associated with the stream vertices. The matrix used to perform the modeling transformation is dynamically programmable by host software.

In step 725, rendering engine 300 may subject the stream vertices to a lighting computation. Lighting intensity values (e.g. color intensity values) may be computed for the vertices of polygonal primitives based on one or more of the following:

(1) the vertex normals;

(2) the position and orientation of a virtual camera in the world coordinate system;

(3) the intensity, position, orientation and type-classification of light sources; and

(4) the material properties of the polygonal primitives such as their intrinsic color values, ambient, diffuse, and/or specular reflection coefficients.

The vertex normals (or changes in normals from one vertex to the next) may be provided as part of the graphics data stream. The rendering pipeline RP(K) may implement any of a wide variety of lighting models. The position and orientation of the virtual camera are dynamically adjustable. Furthermore, the intensity, position, orientation and type-classification of light sources are dynamically adjustable.

It is noted that separate virtual camera positions may be maintained for the viewer's left and right eyes in order to support stereo video. For example, rendering pipeline RP(K) may alternate between the left camera position and the right camera position from one animation frame to the next.

In step 730, the rendering pipeline RP(K) may perform a camera transformation on the vertices of the primitive. The camera transformation may be interpreted as providing the coordinates of the vertices with respect to a camera coordinate system, which is rigidly bound to the virtual camera in the world space. Thus, the camera transformation may require updating whenever the camera position and/or orientation change. The virtual camera position and/or orientation may be controlled by user actions such as manipulations of an input device (such as a joystick, data glove, mouse, light pen, and/or keyboard). In some embodiments, the virtual camera position and/or orientation may be controlled based on measurements of a user's head position and/or orientation and/or eye orientation(s).

In step 735, the rendering pipeline RP(K) may perform a homogenous perspective transformation to map primitives from the camera coordinate system into a clipping space, which is more convenient for a subsequent clipping computation. In some embodiments, steps 730 and 735 may be combined into a single transformation.

In step 737, rendering pipeline RP(K) may assemble the vertices to form primitives such as triangles, lines, etc.

In step 740, rendering pipeline RP(K) may perform a clipping computation on each primitive. In clipping space, the vertices of primitives may be represented as 4 tuples (X,Y,Z,W). In some embodiments, the clipping computation may be implemented by performing a series of inequality tests as follows:

T1=(−W≦X)

T2=(X≦W)

T3=(−W≦Y)

T4=(Y≦W)

T5=(−W≦Z)

T6=(Z≦0)

If all the test flags are true, a vertex resides inside the canonical view volume. If any of the test flags are false, the vertex is outside the canonical view volume. An edge between vertices A and B is inside the canonical view volume if both vertices are inside the canonical view volume. An edge can be trivially rejected if the expression Tk(A) OR Tk(B) is false for any k in the range from one to six. Otherwise, the edge requires testing to determine if it partially intersects the canonical view volume, and if so, to determine the points of intersection of the edge with the clipping planes. A primitive may thus be cut down to one or more interior sub-primitives (i.e. subprimitives that lie inside the canonical view volume). The rendering pipeline RP(K) may compute color intensity values for the new vertices generated by clipping.

Note that the example given above for performing the clipping computation is not meant to be limiting. Other methods may be used for performing the clipping computation.

In step 745, rendering pipeline RP(K) may perform a perspective divide computation on the homogenous post-clipping vertices (X,Y,Z,W) according to the relations

x=X/W

y=Y/W

z=Z/W.

After the perspective divide, the x and y coordinates of each vertex (x,y,z) may reside in a viewport rectangle, for example, a viewport square defined by the inequalities −1≦x≦1 and −1≦y≦1.

In step 750, the rendering pipeline RP(K) may perform a render scale transformation on the post-clipping primitives. The render scale transformation may operate on the x and y coordinates of vertices, and may have the effect of mapping the viewport square in perspective-divided space onto (or into) the spatial bin array in virtual screen space, i.e., onto (or into) a rectangle whose width equals the array horizontal bin resolution M_{B} and whose height equals the array vertical bin resolution N_{B}. Let Xᵥ and Yᵥ denote the horizontal and vertical coordinate respectively in the virtual screen space.

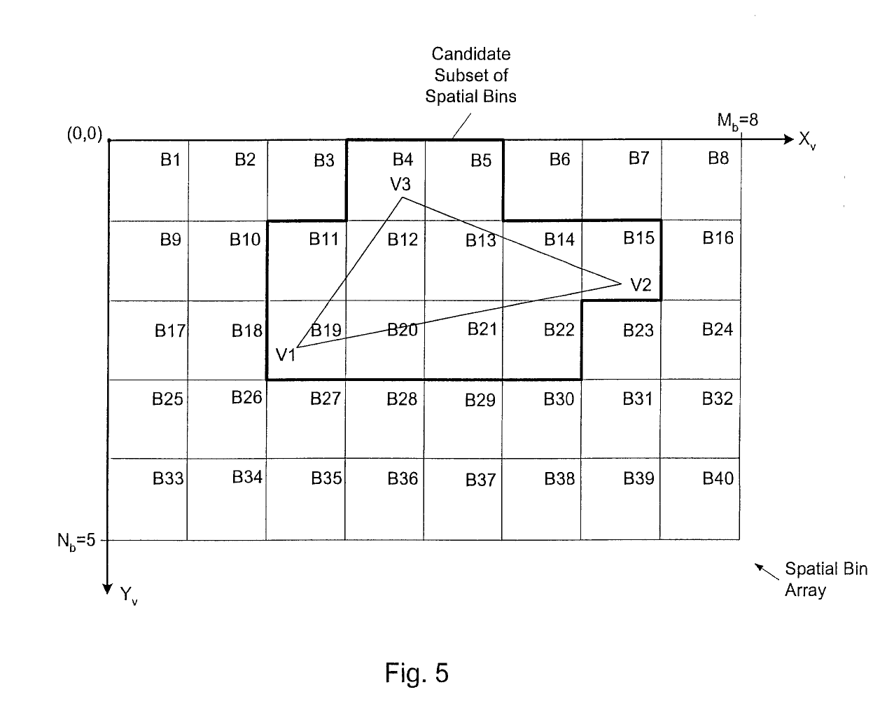

In step 755, the rendering pipeline RP(K) may identify spatial bins which geometrically intersect with the post-scaling primitive as suggested by FIG. 5. Bins in this subset are referred to as “candidate” bins or “intersecting” bins. It is noted that values M_{B}=8 and N_{B}=5 for the dimensions of the spatial bin array have been chosen for sake of illustration, and are much smaller than would typically be used in most applications of graphics system 100.

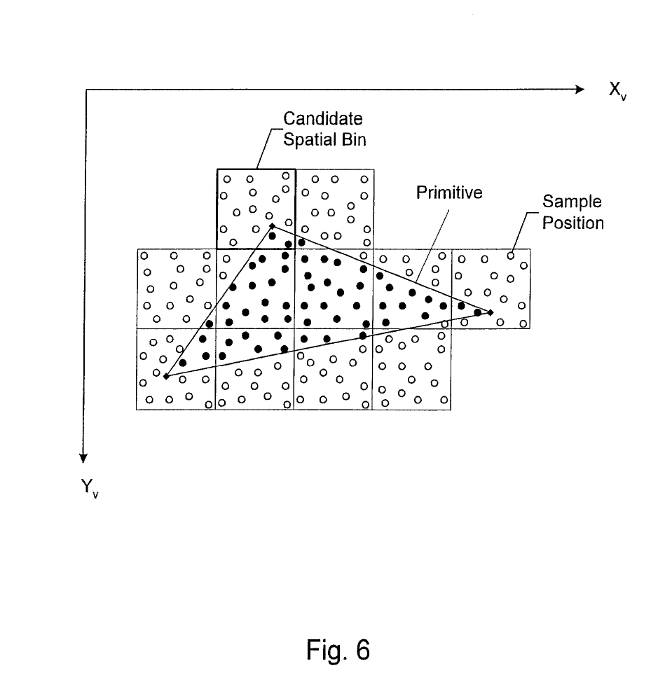

In step 760, the rendering pipeline RP(K) performs a “sample fill” operation on candidate bins identified in step 755 as suggested by FIG. 6. In the sample fill operation, the rendering pipeline RP(K) populates candidate bins with sample positions, identifies which of the sample positions reside interior to the primitive, and computes sample values (such as red, green, blue, z and alpha) at each of the interior sample positions. The rendering pipeline RP(K) may include a plurality of sample fill units to parallelize the sample fill computation. For example, two sample fill units may perform the sample fill operation in parallel on two candidate bins respectively. (This N=2 example generalizes to any number of parallel sample fill units). In FIG. 6, interior sample positions are denoted as small black dots, and exterior sample positions are denoted as small circles.

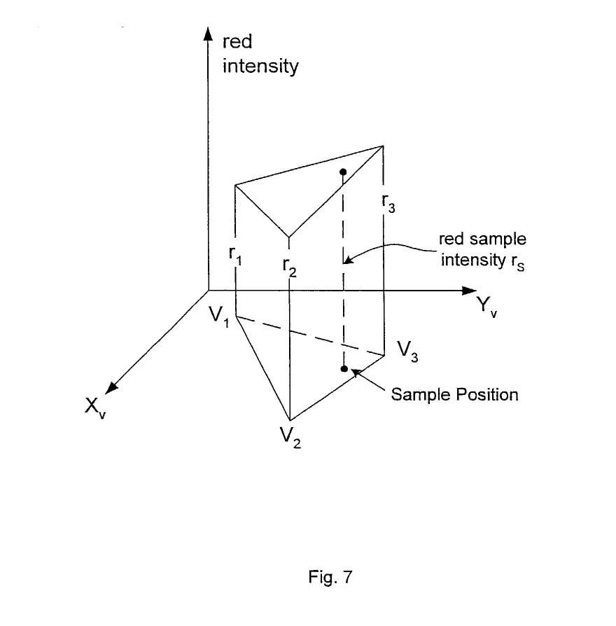

The rendering pipeline RP(K) may compute the color components (r,g,b) for each interior sample position in a candidate bin based on a spatial interpolation of the corresponding vertex color components as suggested by FIG. 7. FIG. 7 suggests a linear interpolation of a red intensity value r_{S} for a sample position inside the triangle defined by the vertices V1, V2, and V3 in virtual screen space (i.e. the horizontal plane of the figure). The red color intensity is shown as the up-down coordinate. Each vertex Vk has a corresponding red intensity value rₖ. Similar interpolations may be performed to determine green, blue, z and alpha values.

In step 765, rendering pipeline RP(K) may compute a vector of texture values for each candidate bin. The rendering pipeline RP(K) may couple to a corresponding texture memory TM(K). The texture memory TM(K) may be used to store one or more layers of texture information. Rendering pipeline RP(K) may use texture coordinates associated with a candidate bin to read texels from the texture memory TM(K). The texels may be filtered to generate the vector of texture values. The rendering pipeline RP(K) may include a plurality of texture filtering units to parallelize the computation of texture values for one or more candidate bins.

The rendering pipeline RP(K) may include a sample fill pipeline which implements step 760 and a texture pipeline which implements step 765. The sample fill pipeline and the texture pipeline may be configured for parallel operation. The sample fill pipeline may perform the sample fill operations on one or more candidate bins while the texture fill pipeline computes the texture values for the one or more candidate bins.

In step 770, the rendering pipeline RP(K) may apply the one or more texture values corresponding to each candidate bin to the color vectors of the interior samples in the candidate bin. Any of a variety of methods may be used to apply the texture values to the sample color vectors.

In step 775, the rendering pipeline RP(K) may forward the computed samples to the scheduling network 400 for storage in the sample buffer 500.

The sample buffer 500 may be configured to support double-buffered operation. The sample buffer may be logically partitioned into two buffer segments A and B. The rendering engine 300 may write into buffer segment A while the filtering engine 600 reads from buffer segment B. At the end of a frame of animation, a host application (running on a host computer) may assert a buffer swap command. In response to the buffer swap command, control of buffer segment A may be transferred to the filtering engine 600, and control of buffer segment B may be transferred to rendering engine 300. Thus, the rendering engine 300 may start writing samples into buffer segment B, and the filtering engine 600 may start reading samples from buffer segment A.

It is noted that usage of the term “double-buffered” does not necessarily imply that all components of samples are double-buffered in the sample buffer 500. For example, sample color may be double-buffered while other components such as z depth may be single-buffered.

In some embodiments, the sample buffer 500 may be triple-buffered or N-fold buffered, where N is greater than two.

Filtration of Samples to Determine Pixels

Filtering engine 600 may access samples from a buffer segment (A or B) of the sample buffer 500, and generate video pixels from the samples. Each buffer segment of sample buffer 500 may be configured to store an M_{B}×N_{B} array of bins. Each bin may store N_{s/b} samples. The values M_{B}, N_{B} and N_{s/b} are programmable parameters.

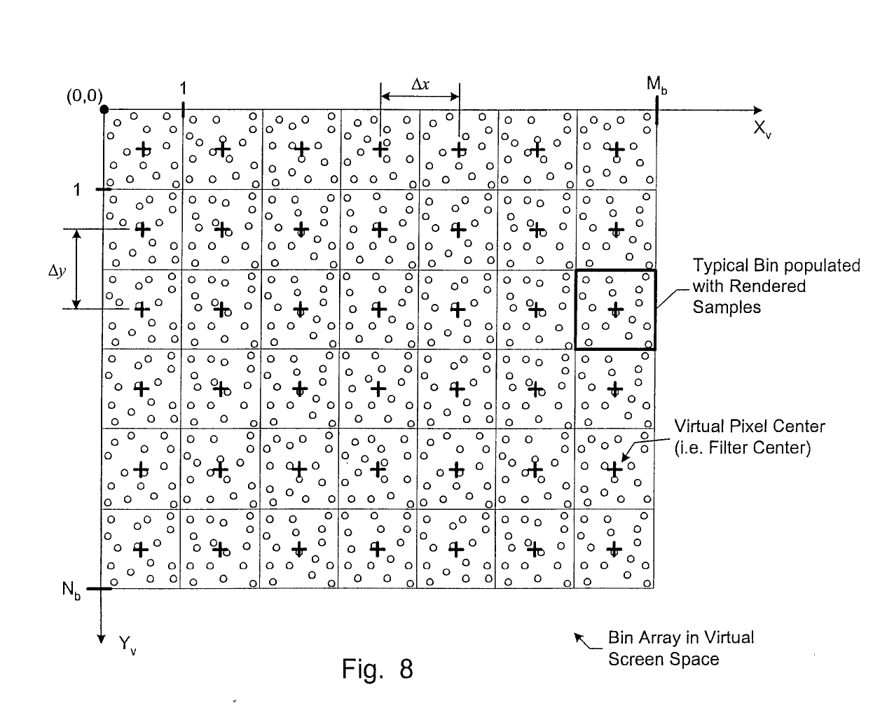

As suggested by FIG. 8, filtering engine 600 may scan through virtual screen space in raster fashion generating virtual pixel positions denoted by the small plus markers, and generating a video pixel at each of the virtual pixel positions based on the samples (small circles) in the neighborhood of the virtual pixel position. The virtual pixel positions are also referred to herein as filter centers (or kernel centers) since the video pixels are computed by means of a filtering of samples. The virtual pixel positions form an array with horizontal displacement ΔX between successive virtual pixel positions in a row and vertical displacement ΔY between successive rows. The first virtual pixel position in the first row is controlled by a start position (Xₛₜₐᵣₜ,Yₛₜₐᵣₜ). The horizontal displacement ΔX, vertical displacement ΔY and the start coordinates Xₛₜₐᵣₜ and Yₛₜₐᵣₜ are programmable parameters.

FIG. 8 illustrates a virtual pixel position at the center of each bin. However, this arrangement of the virtual pixel positions (at the centers of render pixels) is a special case. More generally, the horizontal displacement Δx and vertical displacement Δy may be assigned values greater than or less than one. Furthermore, the start position (Xₛₜₐᵣₜ,Yₛₜₐᵣₜ) is not constrained to lie at the center of a spatial bin. Thus, the vertical resolution N_{P} of the array of virtual pixel centers may be different from N_{B}, and the horizontal resolution M_{P} of the array of virtual pixel centers may be different from M_{B}.

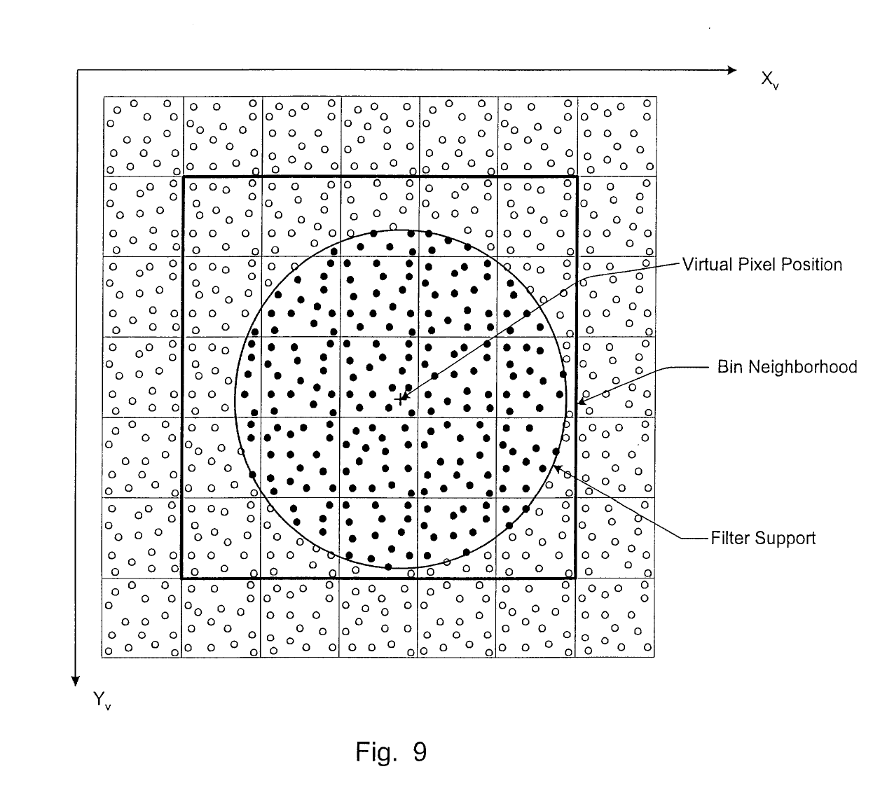

The filtering engine 600 may compute a video pixel at a particular virtual pixel position as suggested by FIG. 9. The filtering engine 600 may compute the video pixel based on a filtration of the samples falling within a support region centered on (or defined by) the virtual pixel position. Each sample S falling within the support region may be assigned a filter coefficient C_{S} based on the sample's position (or some function of the sample's radial distance) with respect to the virtual pixel position.

Each of the color components of the video pixel may be determined by computing a weighted sum of the corresponding sample color components for the samples falling inside the filter support region. For example, the filtering engine 600 may compute an initial red value r_{P} for the video pixel P according to the expression

$${r}_{P} = \sum {C}_{S} {r}_{S} ,$$

where the summation ranges over each sample S in the filter support region, and where r_{S} is the red sample value of the sample S. In other words, the filtering engine 600 may multiply the red component of each sample S in the filter support region by the corresponding filter coefficient C_{S}, and add up the products. Similar weighted summations may be performed to determine an initial green value g_{P}, an initial blue value b_{P}, and optionally, an initial alpha value α_{P} for the video pixel P based on the corresponding components of the samples.

Furthermore, the filtering engine 600 may compute a normalization value E by adding up the filter coefficients C_{S} for the samples S in the bin neighborhood, i.e.,

$$E = \sum {C}_{S} .$$

The initial pixel values may then be multiplied by the reciprocal of E (or equivalently, divided by E) to determine normalized pixel values:

R_{P}=(1/E)*r_{P}

G_{P}=(1/E)*g_{P}

B_{P}=(1/E)*b_{P}

A_{P}=(1/E)*α_{P}.

Filtering engine 600 may include one or more clamp units that clamp the normalized pixel values R_{P}, G_{P}, B_{P}, A_{P} so that the clamped values are restricted to a range such as the interval [0,1). Any of a wide variety of ranges may be used.

In one set of embodiments, the filter coefficient C_{S} for each sample S in the filter support region may be determined by a table lookup. For example, a radially symmetric filter may be realized by a filter coefficient table, which is addressed by a function of a sample's radial distance with respect to the virtual pixel center. The filter support for a radially symmetric filter may be a circular disk as suggested by the example of FIG. 9. The support of a filter is the region in virtual screen space on which the filter is defined. The terms “filter” and “kernel” are used as synonyms herein. Let Rf denote the radius of the circular support disk.

The filtering engine 600 may examine each sample S in a neighborhood of bins containing the filter support region. The bin neighborhood may be a rectangle (or square) of bins. For example, in one embodiment the bin neighborhood is a 5×5 array of bins centered on the bin which contains the virtual pixel position.

The filtering engine 600 may compute the square radius (DS)² of each sample position (X_{S},Y_{S}) in the bin neighborhood with respect to the virtual pixel position (X_{P},Y_{P}) according to the expression

(D_{S})²=(X_{S}−X_{P})²+(Y_{S}−Y_{P})².

The square radius (D_{S})² may be compared to the square radius (R_{f})² of the filter support. If the sample's square radius is less than (or, in a different embodiment, less than or equal to) the filter's square radius, the sample S may be marked as being valid (i.e., inside the filter support). Otherwise, the sample S may be marked as invalid.

The filtering engine 600 may compute a normalized square radius Us for each valid sample S by multiplying the sample's square radius by the reciprocal of the filter's square radius:

$${U}_{S} = {( {D}_{S} )}^{2} \frac{1}{{( {R}_{f} )}^{2}} .$$

The normalized square radius Us may be used to access the filter coefficient table for the filter coefficient C_{S}. The filter coefficient table may store filter weights indexed by the normalized square radius.

In various embodiments, the filter coefficient table is implemented in RAM and is programmable by host software. Thus, the filter function (i.e. the filter kernel) used in the filtering process may be changed as needed or desired. Similarly, the square radius (R_{f})² of the filter support and the reciprocal square radius 1/(R_{f})² of the filter support may be programmable.

Because the entries in the filter coefficient table are indexed according to normalized square distance, they need not be updated when the radius R_{f} of the filter support changes. The filter coefficients and the filter radius may be modified independently.

In one embodiment, the filter coefficient table may be addressed with the sample radius D_{S} at the expense of computing a square root of the square radius (D_{S})². In another embodiment, the square radius may be converted into a floating-point format, and the floating-point square radius may be used to address the filter coefficient table. It is noted that the filter coefficient table may be indexed by any of various radial distance measures. For example, an L¹ norm or L^{infinity} norm may be used to measure the distance between a sample position and the virtual pixel center.

Invalid samples may be assigned the value zero for their filter coefficients. Thus, the invalid samples end up making a null contribution to the pixel value summations. In other embodiments, filtering hardware internal to the filtering engine may be configured to ignore invalid samples. Thus, in these embodiments, it is not necessary to assign filter coefficients to the invalid samples.

In some embodiments, the filtering engine 600 may support multiple filtering modes. For example, in one collection of embodiments, the filtering engine 600 supports a box filtering mode as well as a radially symmetric filtering mode. In the box filtering mode, filtering engine 600 may implement a box filter over a rectangular support region, e.g., a square support region with radius R_{f} (i.e. side length 2R_{f}). Thus, the filtering engine 600 may compute boundary coordinates for the support square according to the expressions X_{P}+R_{f}, X_{P}−R_{f}, Y_{P}+R_{f}, and Y_{P}−R_{f}. Each sample S in the bin neighborhood may be marked as being valid if the sample's position (X_{S},Y_{S}) falls within the support square, i.e., if

X_{P}−R_{f}<X_{S}<X_{P}+R_{f} and

Y_{P}−R_{f}<Y_{S}<Y_{P}+R_{f}.

Otherwise the sample S may be marked as invalid. Each valid sample may be assigned the same filter weight value (e.g., C_{S}=1). It is noted that any or all of the strict inequalities (<) in the system above may be replaced with permissive inequalities (≦). Various embodiments along these lines are contemplated.

The filtering engine 600 may use any of a variety of filters either alone or in combination to compute pixel values from sample values. For example, the filtering engine 600 may use a box filter, a tent filter, a cone filter, a cylinder filter, a Gaussian filter, a Catmull-Rom filter, a Mitchell-Netravali filter, a windowed sinc filter, or in general, any form of band pass filter or any of various approximations to the sinc filter.

In one set of embodiments, the filtering engine 600 may include a set of filtering units FU(0), FU(1), FU(2), . . . , FU(N_{f}−1) operating in parallel, where the number N_{f} of filtering units is a positive integer. For example, in one embodiment, N_{f}=4. In another embodiment, N_{f}=8.

The filtering units may be configured to partition the effort of generating each frame (or field of video). A frame of video may comprise an M_{P}×N_{P} array of pixels, where M_{P} denotes the number of pixels per line, and N_{P} denotes the number of lines. Each filtering unit FU(K) may be configured to generate a corresponding subset of the pixels in the M_{P}×N_{P} pixel array. For example, in the N_{f}=4 case, the pixel array may be partitioned into four vertical stripes, and each filtering unit FU(K), K=0, 1, 2, 3, may be configured to generate the pixels of the corresponding stripe.

Filtering unit FU(K) may include a system of digital circuits, which implement the processing loop suggested below. The values Xₛₜₐᵣₜ(K) and Yₛₜₐᵣₜ(K) represent the start position for the first (e.g. top-left) virtual pixel center in the K^{th} stripe of virtual pixel centers. The values ΔX(K) and ΔY(K) represent respectively the horizontal and vertical step size between virtual pixel centers in the K^{th} stripe. The value M_{H}(K) represents the number of pixels horizontally in the K^{th} stripe. For example, if there are four stripes (N_{f}=4) with equal width, M_{H}(K) may be set equal to M_{P}/4 for K=0, 1, 2, 3. Filtering unit FU(K) may generate a stripe of pixels in a scan line fashion as follows:

I=0;
J=0;
X_{P=X}ₛₜₐᵣₜ(K);
Y_{P=Y}ₛₜₐᵣₜ(K);
while (J<N_{P}) {

while (I < MH(K) {

PixelValues = Filtration(X_{P},Y_{P});
Send Pixel Values to Output Buffer;
X_{P} = X_{P}+ΔX(K);
I = I + 1;
}

X_{P}=Xₛₜₐᵣₜ(K)
Y_{P}=Y_{P}+ΔY(K);
J=J+1;
}

The expression Filtration (X_{P},Y_{P}) represents the filtration of samples in the filter support region of the current virtual pixel position (X_{P},Y_{P}) to determine the components (e.g. RGB values, and optionally, an alpha value) of the current pixel as described above. Once computed, the pixel values may be sent to an output buffer for merging into a video stream. The inner loop generates successive virtual pixel positions within a single row of the stripe. The outer loop generates successive rows. The above fragment may be executed once per video frame (or field). Filtering unit FU(K) may include registers for programming the values Xₛₜₐᵣₜ(K), Yₛₜₐᵣₜ(K), ΔX(K), ΔY(K), and M_{H}(K). These values are dynamically adjustable from host software. Thus, the graphics system 100 may be configured to support arbitrary video formats.

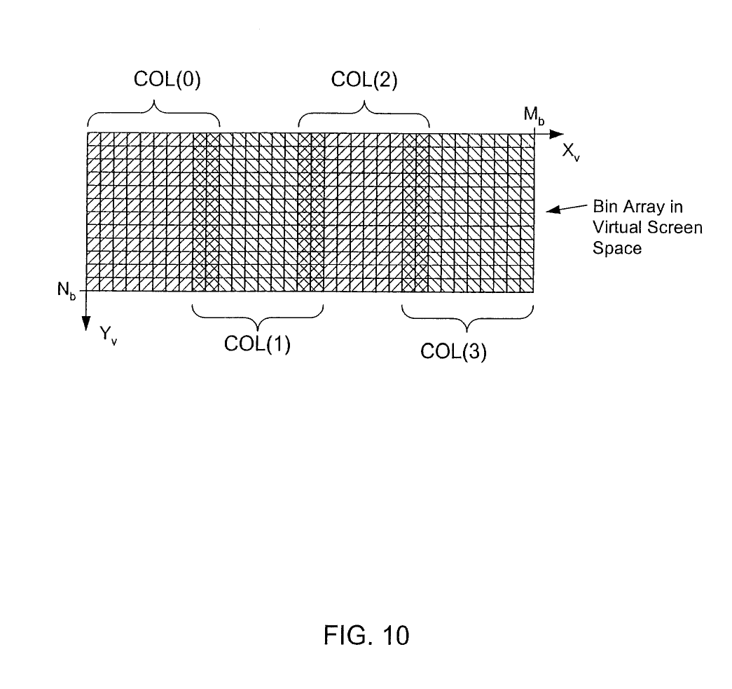

Each filtering unit FU(K) accesses a corresponding subset of bins from the sample buffer 500 to generate the pixels of the K^{th} stripe. For example, each filtering unit FU(K) may access bins corresponding to a column COL(K) of the bin array in virtual screen space as suggested by FIG. 10. Each column may be a rectangular subarray of bins. Note that column COL(K) may overlap with adjacent columns. This is a result of using a filter function with filter support that covers more than one spatial bin. Thus, the amount of overlap between adjacent columns may depend on the radius of the filter support.

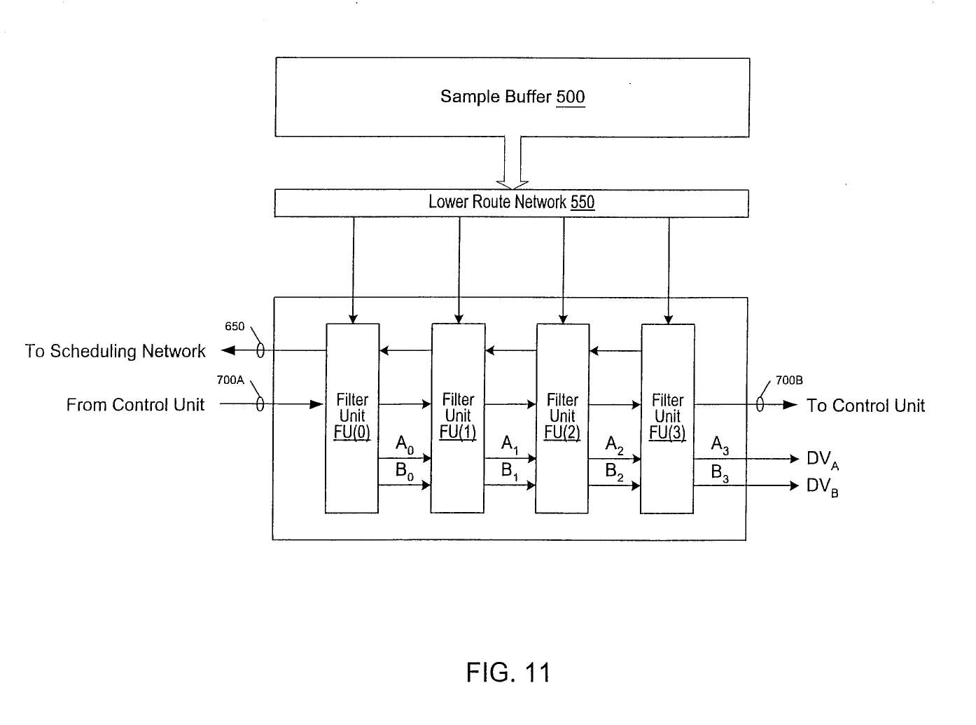

The filtering units may be coupled together in a linear succession as suggested by FIG. 11 in the case N_{f}=4. Except for the first filtering unit FU(0) and the last filtering unit FU(N_{f}−1), each filtering unit FU(K) may be configured to receive digital video input streams A_{K-1} and B_{K-1} from a previous filtering unit FU(K−1), and to transmit digital video output streams A_{K} and B_{K} to the next filtering unit FU(K+1). The first filtering unit FU(0) generates video streams A₀ and B₀ and transmits these streams to filtering unit FU(1). The last filtering unit FU(N_{f}−1) receives digital video streams A_{Nf-2} and B_{Nf-2} from the previous filtering unit FU(N_{f}−2), and generates digital video output streams A_{Nf-1} and B_{Nf-1} also referred to as video streams DV_{A} and DV_{B} respectively. Video streams A₀, A₁, . . . , A_{Nf-1} are said to belong to video stream A. Similarly, video streams B₀, B₁, . . . , B_{Nf-1} are said to belong to video stream B.

Each filtering unit FU(K) may be programmed to mix (or substitute) its computed pixel values into either video stream A or video stream B. For example, if the filtering unit FU(K) is assigned to video stream A, the filtering unit FU(K) may mix (or substitute) its computed pixel values into video stream A, and pass video stream B unmodified to the next filtering unit FU(K+1). In other words, the filtering unit FU(K) may mix (or replace) at least a subset of the dummy pixel values present in video stream A_{K-1} with its locally computed pixel values. The resultant video stream A_{K} is transmitted to the next filtering unit. The first filtering unit FU(0) may generate video streams A₋₁ and B₋₁ containing dummy pixels (e.g., pixels having a background color), and mix (or substitute) its computed pixel values into either video stream A₋₁ or B₋₁, and pass the resulting streams A₀ and B₀ to the filtering unit FU(1). Thus, the video streams A and B mature into complete video signals as they are operated on by the linear succession of filtering units.

The filtering unit FU(K) may also be configured with one or more of the following features: color look-up using pseudo color tables, direct color, inverse gamma correction, and conversion of pixels to non-linear light space. Other features may include programmable video timing generators, programmable pixel clock synthesizers, cursor generators, and crossbar functions.

While much of the present discussion has focused on the case where N_{f}=4, it is noted that the inventive principles described in this special case naturally generalize to arbitrary values for the parameter N_{f} (the number of filtering units).

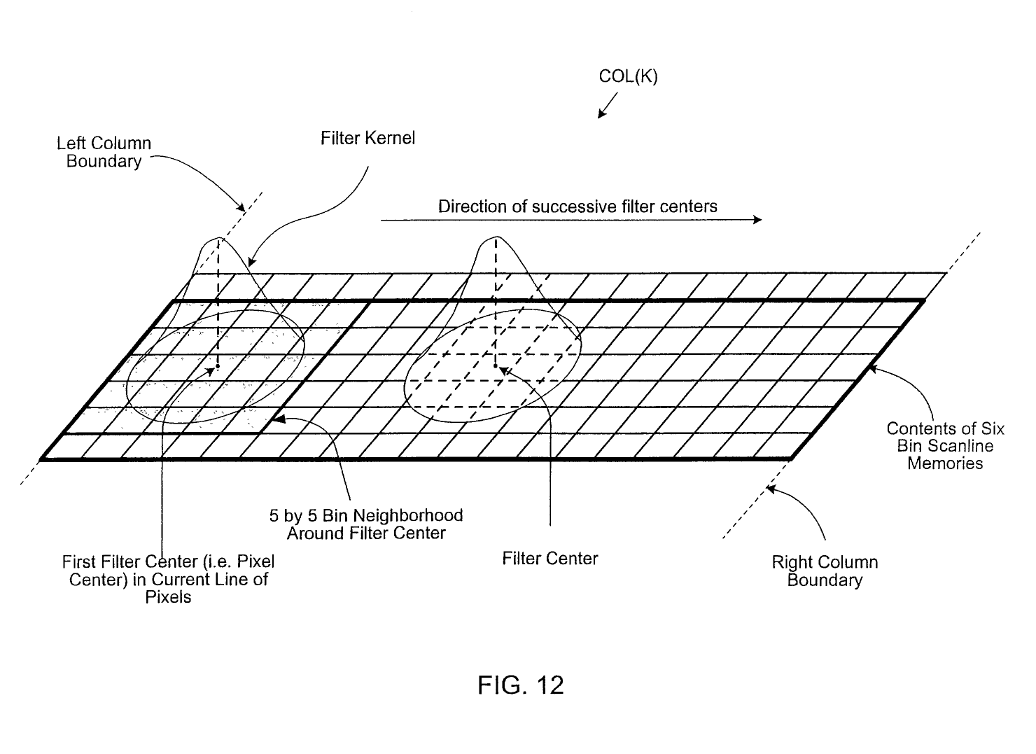

In one set of embodiments, each filtering unit FU(K) may include (or couple to) a plurality of bin scanline memories (BSMs). Each bin scanline memory may contain sufficient capacity to store a horizontal line of bins within the corresponding column COL(K). For example, in some embodiments, filtering unit FU(K) may include six bin scanline memories as suggested by FIG. 12.

Filtering unit FU(K) may move the filter centers through the column COL(K) in a raster fashion, and generate a pixel at each filter center. The bin scanline memories may be used to provide fast access to the memory bins used for a line of pixel centers. As the filtering unit FU(K) may use samples in a 5 by 5 neighborhood of bins around a pixel center to compute a pixel, successive pixels in a line of pixels end up using a horizontal band of bins that spans the column and measures five bins vertically. Five of the bin scan lines memories may store the bins of the current horizontal band. The sixth bin scan line memory may store the next line of bins, after the current band of five, so that the filtering unit FU(K) may immediately begin computation of pixels at the next line of pixel centers when it reaches the end of the current line of pixel centers.

As the vertical displacement ΔY between successive lines of virtual pixels centers may be less than the vertical size of a bin, not every vertical step to a new line of pixel centers necessarily implies use of a new line of bins. Thus, a vertical step to a new line of pixel centers will be referred to as a nontrivial drop down when it implies the need for a new line of bins. Each time the filtering unit FU(K) makes a nontrivial drop down to a new line of pixel centers, one of the bin scan line memories may be loaded with a line of bins in anticipation of the next nontrivial drop down.

Much of the above discussion has focused on the use of six bin scanline memories in each filtering unit. However, more generally, the number of bin scanline memories may be one larger than the diameter (or side length) of the bin neighborhood used for the computation of a single pixel. (For example, in an alternative embodiment, the bin neighborhood may be a 7×7 array of bins.)

Furthermore, each of the filtering units FU(K) may include a bin cache array to store the memory bins that are immediately involved in a pixel computation. For example, in some embodiments, each filtering unit FU(K) may include a 5×5 bin cache array, which stores the 5×5 neighborhood of bins that are used in the computation of a single pixel. The bin cache array may be loaded from the bin scanline memories.

As noted above, each rendering pipeline of the rendering engine 300 generates sample positions in the process of rendering primitives. Sample positions within a given spatial bin may be generated by adding a vector displacement (ΔX,ΔY) to the vector position (X_{bin},Y_{bin}) of the bin's origin (e.g. the top-left corner of the bin). To generate a set of sample positions within a spatial bin implies adding a corresponding set of vector displacements to the bin origin. To facilitate the generation of sample positions, each rendering pipeline may include a programmable jitter table which stores a collection of vector displacements (ΔX,ΔY). The jitter table may have sufficient capacity to store vector displacements for an M_{J}×N_{J} tile of bins. Assuming a maximum sample position density of Dₘₐₓ samples per bin, the jitter table may then store M_{J}*N_{J}*Dₘₐₓ vector displacements to support the tile of bins. Host software may load the jitter table with a pseudo-random pattern of vector displacements to induce a pseudo-random pattern of sample positions. In one embodiment, M_{J}=N_{J}=2 and Dₘₐₓ=16.

A straightforward application of the jitter table may result in a sample position pattern, which repeats with a horizontal period equal to M_{J} bins, and a vertical period equal to N_{J} bins. However, in order to generate more apparent randomness in the pattern of sample positions, each rendering engine may also include a permutation circuit, which applies transformations to the address bits going into the jitter table and/or transformations to the vector displacements coming out of the jitter table. The transformations depend on the bin horizontal address X_{bin} and the bin vertical address Y_{bin}.

Each rendering unit may employ such a jitter table and permutation circuit to generate sample positions. The sample positions are used to compute samples, and the samples are written into sample buffer 500. Each filtering unit of the filtering engine 600 reads samples from sample buffer 500, and may filter the samples to generate pixels. Each filtering unit may include a copy of the jitter table and permutation circuit, and thus, may reconstruct the sample positions for the samples it receives from the sample buffer 500, i.e., the same sample positions that are used to compute the samples in the rendering pipelines. Thus, the sample positions need not be stored in sample buffer 500.

As noted above, sample buffer 500 stores the samples, which are generated by the rendering pipelines and used by the filtering engine 600 to generate pixels. The sample buffer 500 may include an array of memory devices, e.g., memory devices such as SRAMs, SDRAMs, RDRAMs, 3DRAMs or 3DRAM64s. In one collection of embodiments, the memory devices are 3DRAM64 devices manufactured by Mitsubishi Electric Corporation.

RAM is an acronym for random access memory.

SRAM is an acronym for static random access memory.

DRAM is an acronym for dynamic random access memory.

SDRAM is an acronym for synchronous dynamic random access memory.

RDRAM is an acronym for Rambus DRAM.

The memory devices of the sample buffer may be organized into N_{MB} memory banks denoted MB(0), MB(1), MB(2), . . . , MB(N_{MB}−1), where N_{MB} is a positive integer. For example, in one embodiment, N_{MB} equals eight. In another embodiment, N_{MB} equals sixteen.

Each memory bank MB may include a number of memory devices. For example, in some embodiments, each memory bank includes four memory devices.

Each memory device stores an array of data items. Each data item may have sufficient capacity to store sample color in a double-buffered fashion, and other sample components such as z depth in a single-buffered fashion. For example, in one set of embodiments, each data item may include 116 bits of sample data defined as follows:

30 bits of sample color (for front buffer),

30 bits of sample color (for back buffer),

16 bits of alpha and/or overlay,

10 bits of window ID,

26 bits of z depth, and

4 bits of stencil.

Each of the memory devices may include one or more pixel processors, referred to herein as memory-integrated pixel processors. The 3DRAM and 3DRAM64 memory devices manufactured by Mitsubishi Electric Corporation have such memory-integrated pixel processors. The memory-integrated pixel processors may be configured to apply processing operations such as blending, stenciling, and Z buffering to samples. 3DRAM64s are specialized memory devices configured to support internal double-buffering with single buffered Z in one chip.

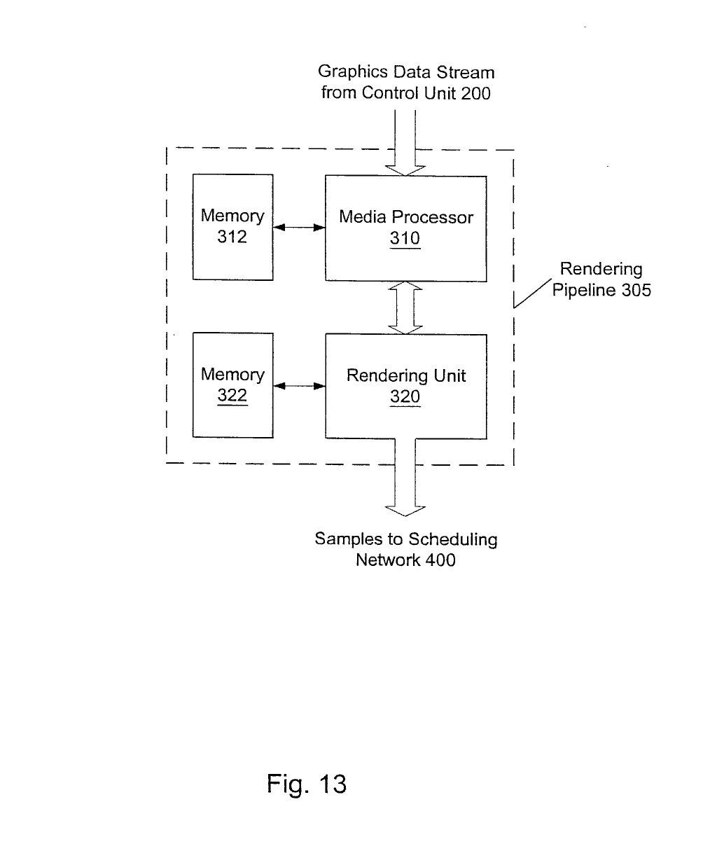

As described above, the rendering engine 300 may include a set of rendering pipelines RP(0), RP(1), . . . , RP(N_{PL}−1). FIG. 13 illustrates one embodiment of a rendering pipeline 305 that may be used to implement each of the rendering pipelines RP(0), RP(1), . . . , RP(N_{PL}−1). The rendering pipeline 305 may include a media processor 310 and a rendering unit 320.

The media processor 310 may operate on a stream of graphics data received from the control unit 200. For example, the media processor 310 may perform the three-dimensional transformation operations and lighting operations such as those indicated by steps 710 through 735 of FIG. 4. The media processor 310 may be configured to support the decompression of compressed geometry data.

The media processor 310 may couple to a memory 312, and may include one or more microprocessor units. The memory 312 may be used to store program instructions and/or data for the microprocessor units. (Memory 312 may also be used to store display lists and/or vertex texture maps.) In one embodiment, memory 312 comprises direct Rambus DRAM (i.e. DRDRAM) devices.

The rendering unit 320 may receive transformed and lit vertices from the media processor, and perform processing operations such as those indicated by steps 737 through 775 of FIG. 4. In one set of embodiments, the rendering unit 320 is an application specific integrated circuit (ASIC). The rendering unit 320 may couple to memory 322 which may be used to store texture information (e.g., one or more layers of textures). Memory 322 may comprise SDRAM (synchronous dynamic random access memory) devices. The rendering unit 310 may send computed samples to sample buffer 500 through scheduling network 400.

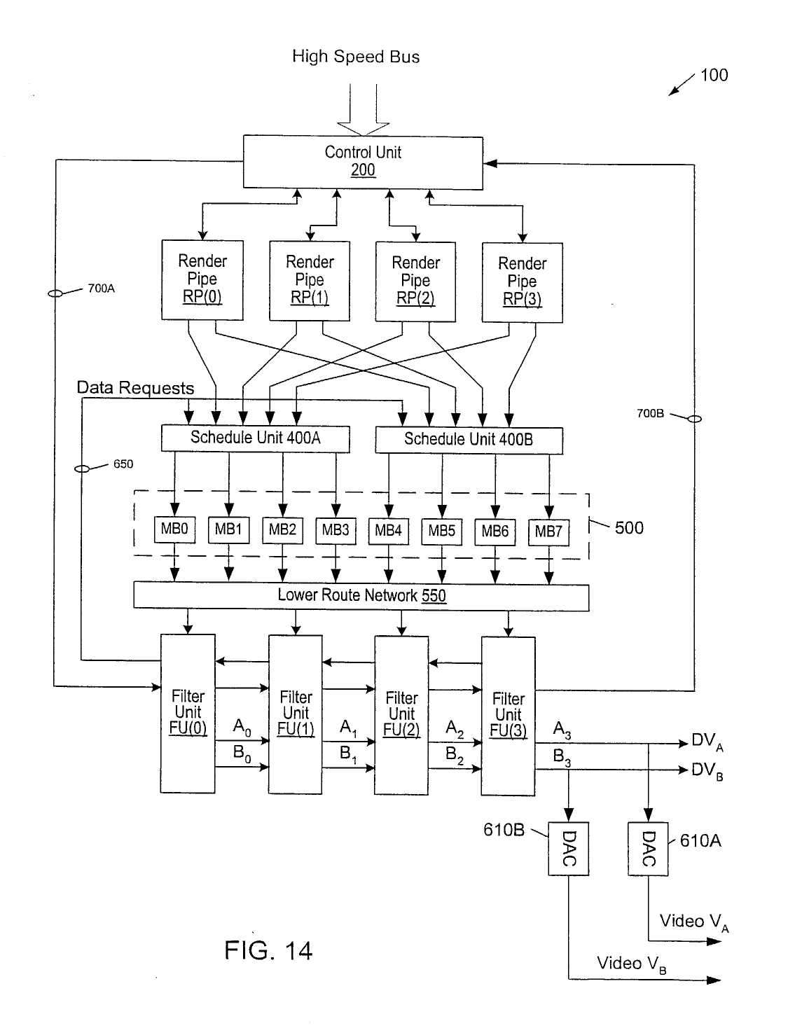

FIG. 14 illustrates one embodiment of the graphics accelerator 100. In this embodiment, the rendering engine 300 includes four rendering pipelines RP(0) through RP(3), scheduling network 400 includes two schedule units 400A and 400B, sample buffer 500 includes eight memory banks MB(0) through MB(7), and filtering engine 600 includes four filtering units FU(0) through FU(3). The filtering units may generate two digital video streams DV_{A} and DV_{B}. The digital video streams DV_{A} and DV_{B} may be supplied to digital-to-analog converters (DACs) 610A and 610B, where they are converted into analog video signals V_{A} and V_{B} respectively. The analog video signals are supplied to video output ports. In addition, the graphics system 100 may include one or more video encoders. For example, the graphics system 100 may include an S-video encoder.

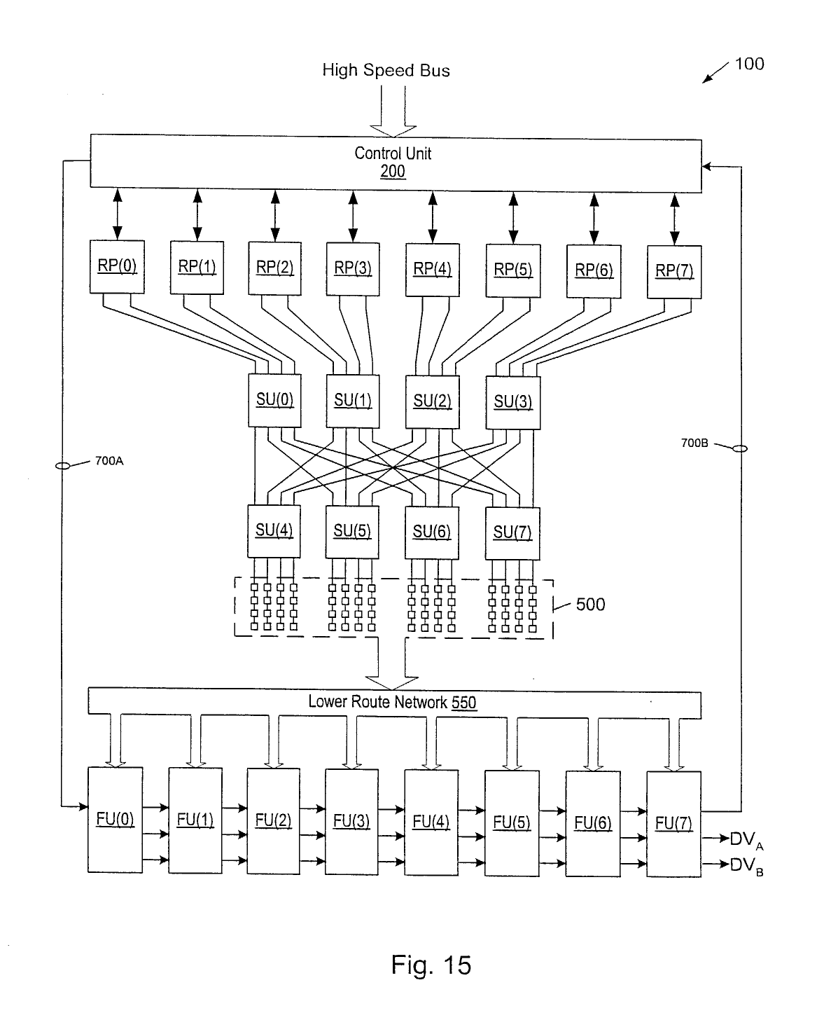

FIG. 15 illustrates another embodiment of graphics system 100. In this embodiment, the rendering engine 300 includes eight rendering pipelines RP(0) through RP(7), the scheduling network 400 includes eight schedule units SU(0) through SU(7), the sample buffer 500 includes sixteen memory banks, the filtering engine 600 includes eight filtering units FU(0) through FU(7). This embodiment of graphics system 100 also includes DACs to convert the digital video streams DV_{A} and DV_{B} into analog video signals.

Observe that the schedule units are organized as two layers. The rendering pipelines couple to the first layer of schedule unit SU(0) through SU(3). The first layer of schedule units couple to the second layer of schedule units SU(4) through SU(7). Each of the schedule units in the second layer couples to four banks of memory device in sample buffer 500.

The embodiments illustrated in FIGS. 14 and 15 are meant to suggest a vast ensemble of embodiments that are obtainable by varying design parameters such as the number of rendering pipelines, the number of schedule units, the number of memory banks, the number of filtering units, the number of video channels generated by the filtering units, etc.

Statistic Logic for Development Pixel Component Histograms

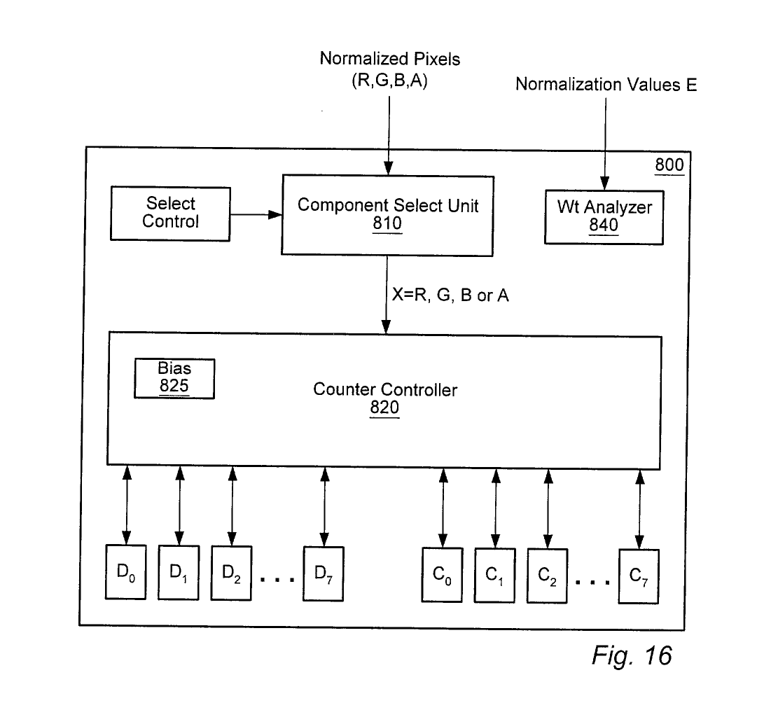

FIG. 16 illustrates one embodiment of statistic logic unit 800 configured to develop a histogram of the exponent values for normalized pixel components. The statistic logic unit 800 may include a component select unit 810, a counter controller 820, and a set of positive counters C₀, C₁, . . . , C₇, and a set of negative counters D₀, D₁, . . . , D₇. While the present example assumes sixteen counters with eight positive counters and eight negative counters, it is to be understood that the inventive principles described herein naturally generalize to any number of positive counters and any number of negative counters.

Each of the filtering units FU(K), K=0, 1, 2, . . . , N_{f}, may include one of the statistic logic units 800. The component select unit 810 receives a stream of normalized pixels generated by a filtering unit FU(K). (The process of filtering samples to compute normalized pixel values is described above.) Each normalized pixel may include a number of components such as red, green, blue and alpha. The component select unit 810 may be programmed to select one of the pixel components in each normalized pixel of the input stream. The selected component is denoted as X in FIG. 16. The selected component X may have the form X=(−1)^{S}*0.mantissa*2^{V}, where S is the sign bit, and V is the base-two exponent.

Counter controller 820 is configured to control positive counters C₀, C₁, . . . , C₇, and negative counters D₀, D₁, . . . , D₇ to develop a histogram for the exponent V of the selected pixel component X of each normalized pixel in the input pixel stream. Counter controller 820 includes a programmable bias register 825. The bias register holds an integer value B that controls which range of exponents V are accumulated in the positive and negative counters.

Counter controller 820 may compute a counter select index K=V+B+1. If the sign bit S indicates that X is a positive quantity, counter controller increments:

positive counter C₀ if K is in the range K≦0;

positive counter C_{K} if K is in the range 1≦K≦6;

positive counter C₇ if K is in the range K≧7.

If the sign bit S indicates that X is a negative quantity, counter controller increments:

negative counter D₀ if K is in the range K≦0;

negative counter D_{K} if K is in the range 1≦K≦6;

negative counter D₇ if K is in the range K≧7.

Thus, each of the positive counters counts of the number of occurrences of a corresponding exponent V (or a corresponding interval in exponent V) in the positive X values in the received input stream. Similarly, each of the negative counters counts of the number of occurrences of a corresponding exponent V (or a corresponding interval in exponent V) in the negative X values of the received input stream.

A host application executing on the host computer may send a histogram upload command to one or more static logic units 800 in one or more of the filtering units FU(0), FU(1), . . . , FU(N_{f}−1) through the communication bus 700.

As illustrated in FIGS. 1, 11, 14 and 15, communication bus 700 may include an outgoing segment 700A extending from the control unit 200 to the first filtering unit FU(0), and an outgoing segment extending from the last filtering unit FU(N_{f}−1) to the control unit 200. In one set of embodiments, the communication bus 700 may include a series of segments which link successive filtering units of the filtering engine 600 as described in U.S. patent application Ser. No. 09/894,068, filed on Jun. 28, 2001, entitled “Graphics System with Real-Time Convolved Pixel Readback”, invented by Michael F. Deering and Nathaniel D. Naegle. This patent application is hereby incorporated by reference in its entirety.

In response to receive a histogram upload command, the counter controller 820 in a filtering unit FU(K) may be configured to read the count values of the positive and negative counters, and to transmit the count values to the host application through the segmented communication bus. The host application may automatically adjust the filter coefficients used by the filtering unit FU(K) based on the count values. For example, the host application may adjust the filter coefficients to control or minimize an amount of negativity in the select pixel component, or, to control or minimize the amount of super-brightness in the selected component, i.e. the amount by which the selected pixel component exceeds a maximum displayable value intensity.

Please refer to U.S. patent application Ser. No. 09/751,673, filed on Dec. 29, 2000, entitled “Dynamically Adjusting a Sample-to-Pixel Filter to Compensate for the Effects of Negative Lobes”, invented by Michael F. Deering, for a description of control methods that involve dynamic filter adjustments. This application is hereby incorporated by reference in its entirety.

In one set of embodiments, the host application may present the count values (and/or refined statistics derived from the count values) to a user through a graphical user interface. (The host computer may include a display and input devices such as a mouse and keyboard.) The user may provide inputs through the graphical user interface to control the filter used by the filtering units (or by some subset of the filtering units).

In one embodiment, the counter controller 820 may be configured to copy the count values of the positive and negative counters in response to receiving an end-of-frame (or end-of-field) signal into a temporary buffer. The temporary buffer may reside in the counter controller 820. After copying the count values, the counter controller 820 may reset the counters to zero in anticipation of the next frame (or field) of pixels. The host application may read the count values from the temporary buffer.

In another embodiment, the counter controller 820 may be configured to send the count values of the positive and negative counters to the host application through the communication bus 700 in response to receiving an end-of-frame (or end-of-field) signal into a temporary buffer.

In some embodiments, the statistic logic unit may also include a weight analyzer 840. The weight analyzer 840 receives a stream of normalization values E which are used to compute the normalized pixel values X. The normalization value E may be expressed in a floating point form such as E=(−1)^{T}*0.mantissa*2^{(G-W)}, where T is the sign bit and W is exponent. In one embodiment, G equals nine. However, G may take any of a variety of integer values.

The weight analyzer 840 may determine if the normalization value E ever attains the value zero. The weight analyzer 840 sets a GOTZERO bit to one in response to the first occurrence of the normalization value E equaling zero. The GOTZERO bit thereafter stays equal to one until reset after the end of the frame.

The weight analyzer 840 may also determine if the normalization value E ever goes negative. The weight analyzer 840 sets a GOTNEG bit to one in response to the first occurrence of a normalization value E being negative. The GOTNEG bit thereafter stays equal to one until reset after the end of the frame.

In one embodiment, the weight analyzer 840 may maintain a running minimum W_{MIN} of the exponent W by performing the operation W_{MIN}←minimum{W, W_{MIN}} for each received normalization value E, wherein the minimum function selects the argument W or W_{MIN} which is closest to minus infinity. In another embodiment, the weight analyzer 840 may include a minimizer circuit which takes into account the sign bit T of the normalization value E and the GOTNEG bit to implement a more elaborate “minimization”. Recall the sign bit T equals one if the normalization value E is negative. And the GOTZERO bit gets stuck to one at the first occurrence of a negative E value. The minimizer circuit may implement the computation:

W_{MIN}←minimum {W,W_{MIN}} if T=0 and GOTNEG=0;

W_{MIN}←W if T=1 and GOTNEG=0;

W_{MIN}←W_{MIN} if T=0 and GOTNEG=1;

W_{MIN}←maximum{W,W_{MIN}} if T=1 and GOTNEG=1.

The minimizer circuit may include a multiplexor circuit, a subtraction circuit and a set of logic gates to implement the computation above.

The value W_{MIN} and the stick bits GOTZERO and GOTNEG may be reported to the host application along with the counter values. The host application may perform control adjustments to the sample filter of the filtering units based on the values of the value W_{MIN} and/or the sticky bits. Alternatively, the host application may present the values W_{MIN} and/or indications of the sticky bit values to a user. The user may provide inputs that direct the adjustment of the filter (e.g. the filter function and/or the filter support region).

Numerous variations and modifications will become apparent to those skilled in the art once the above disclosure is fully appreciated. It is intended that the following claims be interpreted to embrace all such variations and modifications.

What is claimed is:

1. A system comprising:
a rendering engine configured to render samples in response to received graphics data;
a sample buffer configured to receive and store the samples;
a filtering unit configured to read and filter samples stored in the sample buffer to generate pixel values, wherein the filtering unit includes a counter controller, a set of positive counters and a set of negative counters, wherein the counter controller is configured to accumulate a histogram of exponent values of the pixel values in the positive counters and negative counters, wherein the positive counters maintain count values for positively signed pixel values and the negative counters maintain count values for negatively signed pixel values.

2. A method for generating pixels for a display device, the method comprising:
receiving graphics data;
rendering a first plurality of samples for a frame in response to said graphics data;
filtering said first plurality of samples using a first filter to generate a first set of pixel value for said frame;
computing a histogram of the pixel values, wherein cells of the histogram have binary widths;
adjusting the first filter based on the histogram.

3. The method of claim 2, wherein said adjusting the first filter include adjusting a filter function associated with the first filter.

4. The method of claim 2, wherein said adjusting the first filter include adjusting a support region of the first filter.

5. A method for generating pixels for a display device, the method comprising:
receiving graphics data;
rendering a first plurality of samples for a frame in response to said graphics data;
filtering said first plurality of samples using a first filter to generate a first set of pixel values for said frame;
computing a histogram of exponent values of the first set of pixel values;
uploading the histogram to a host program running on a host computer; and
the host program adjusting the first filter based on the uploaded histogram.

6. A graphics accelerator comprising:
pixel computation circuit configured to generate pixel values;
a plurality of counters;
a counter controller configured to receive a stream of pixel values from the pixel computation circuit, wherein the counter controller is configured to accumulate a histogram of exponent values of the pixel values in the counters, wherein the histogram values accumulated in the counters are readable by a host computer coupled to the graphics accelerator.
